(19) United States
(12) Patent Application Publication
(10) Pub. No.: US 2016/0217269 A1
(43) Pub. Date: Jul. 28, 2016

(54) DATA SYSTEM FOR THE IDENTIFICATION OF RADIOLOGY DATASETS

(71) Applicant: Siemens Aktiengesellschaft, München (DE)

(72) Inventors: Michael GOETTGES, Nuernberg (DE); Daniel LERCH, Weilersbach (DE); Carsten THIERFELDER, Pinzberg (DE)

(21) Appl. No.: 15/000,070

(22) Filed: Jan. 19, 2016

(30) Foreign Application Priority Data
Jan. 27, 2015 (DE) 102015201361.8

(51) Int. Cl. G06F 19/00; G06F 21/62; G06F 17/30

(52) U.S. Cl. CPC G06F 19/3443; G06F 19/321; G06F 19/322; G06F 17/30265; G06F 21/6245

(57) ABSTRACT

A database system is disclosed for the identification of technical parameters for an imaging device. In an embodiment, the database system includes a first retrieval facility for retrieval of a radiology dataset from a medical examination of a user from a database; a second retrieval facility for retrieval of radiology datasets from a comparable medical examination of other users from the database; an anonymization facility for anonymizing the radiology datasets of the other users; and an analysis facility for analyzing the radiology dataset of the one user on the basis of the anonymized radiology datasets of the other users.

### PRIORITY STATEMENT

The present application hereby claims priority under 35 U.S.C. §119 to German patent application number DE 102015201361.8 filed Jan. 27, 2015, the entire contents of which are hereby incorporated herein by reference.

### FIELD

At least one embodiment of the present invention generally relates to a database system and/or a method for the identification of technically advantageous parameters for an imaging device.

### BACKGROUND

An applied X-ray dose is an important technical parameter with regard to imaging using ionizing radiation and X-ray based radiology methods, in particular computed tomography. Various challenges are encountered on the way to lower radiation doses. With respect to a patient an X-ray dose is to be kept as low as possible and with respect to regulatory authorities it is necessary to prove that guidelines relating to the observance of dose limit values are being observed. According to the legislation, said proof is to be provided for an individual device or for the entire number of devices held available.

In order to continuously reduce the X-ray dose it is helpful if it is possible to keep track for each individual device, each user and each type of clinical examination of the extent to which there are individual devices or users which achieve poorer or better dose values than other devices for certain clinical applications. Only if corresponding outliers at the upper end are recognized in the X-ray dose is it possible to identify a potential for improvement and to improve the dose level achieved by adapting processes or protocols, training personnel, upgrading or exchanging the devices. A potential for improvement in respect of the X-ray dose across all the devices of one healthcare provider can then in turn only be identified if a comparison with other institutions can be effected.

Beyond the legal obligation to observe dose limit values and the medically ethical obligation to minimize X-ray doses (ALARA—“as low as reasonably achievable”), the improvement of the dose efficiency achieved for a healthcare provider represents an advantage if said healthcare provider is able to make an achieved low dose level transparent to third parties and thus utilize said dose advantage as a marketing advantage.

Users of imaging devices of all types, such as for example those which operate with non-ionizing radiation, would also want to be able to monitor further technical parameters for said devices in addition to the dose values in order to purposefully improve said further technical parameters, such as for example a patient throughput, a duration of examinations (itemized according to clinical indication), an error rate, a repetition rate or a mixture of clinical examinations performed. The users are moreover similarly interested in improving the image quality of the imaging devices.

The acquisition of performance data for the imaging devices is complex. If improvement measures are identified on the basis of dose or performance analyses, today's monitoring services then leave the question fully open as to whether the problem is caused by a lack of user training, poor equipment or the absence of software licenses. It is therefore left to the user to find a remedy on the basis of a suspicion by modifying technical parameters for the examination.

### SUMMARY

At least one embodiment of the present invention enables a simple identification of advantageous technical parameters in imaging devices.

According to a first aspect of an embodiment, a database system for the identification of technical parameters for an imaging device is disclosed, having a first retrieval facility for retrieval of a radiology dataset from a medical examination of a user from a database; a second retrieval facility for retrieval of radiology datasets from a comparable medical examination of other users from the database; an anonymization facility for anonymizing the radiology datasets of the other users; and an analysis facility for analyzing the radiology dataset of the one user on the basis of the anonymized radiology datasets of the other users. The radiology datasets can comprise a captured image as well as technical parameters which have been used for capturing the image via an imaging device, such as for example an associated X-ray dose or radiation dose or a protocol for the examination.

According to a second aspect of an embodiment, a method for the identification of technical parameters for an imaging device is disclosed, comprising the steps of storing radiology datasets of a number of users in a database; retrieving the radiology dataset from a medical examination of a user from the database; retrieving radiology datasets from a comparable medical examination of other users from the database; anonymizing the radiology datasets of the other users; and analyzing the radiology dataset of the one user on the basis of the anonymized radiology datasets of the other users. The same technical advantages are thereby achieved as by the database system according to the first aspect.

According to a third aspect of an embodiment, a computer program product is disclosed, which is loaded, or can be loaded, into a memory of a computer, with computer program code for carrying out an embodiment of the method described above when the computer program product is executed on the computer.

According to a fourth aspect of an embodiment, a computer program is disclosed, with computer program code for carrying out all the method steps of an embodiment of the method described above when the computer program product is executed on a computer. In this situation it is also possible that the computer program is stored on a medium which can be read by a computer.

According to a first aspect of an embodiment, a database system for the identification of technical parameters for an imaging device is disclosed, having a first retrieval facility for retrieval of a radiology dataset from a medical examination of a user from a database; a second retrieval facility for retrieval of radiology datasets from a comparable medical examination of other users from the database; an anonymization facility for anonymizing the radiology datasets of the other users; and an analysis facility for analyzing the radiology dataset of the one user on the basis of the anonymized radiology datasets of the other users. The radiology datasets can comprise a captured image as well as technical parameters which have been used for capturing the image via an imaging device, such as for example an associated X-ray dose or radiation dose or a protocol for the examination.

The technical advantage is thereby achieved for example that the user is able to view his own radiology datasets from a medical examination in their full depth in the database system, but that the radiology datasets of other users are made available in anonymized form for the purposes of analysis and comparison, for example in the form of freely definable average key values (PKI—key performance indices). The setting of technical parameters in the imaging device can be optimized through direct comparison of the radiology datasets.

In a technically advantageous embodiment of the database system the radiology dataset comprises an X-ray dose from the medical examination and/or an examination image from the medical examination. The technical advantage is thereby achieved for example that low X-ray doses can be identified which nevertheless result in a high image quality.

In a further technically advantageous embodiment of the database system, the second retrieval facility is designed in order to retrieve the radiology datasets of a predefined user group from the database. The technical advantage is thereby achieved for example that the user group can be restricted to a predefined circle of users having special characteristics for the purpose of analysis of the radiology datasets.

In a further technically advantageous embodiment of the database system, the predefined user group can be restricted locally. The technical advantage is thereby achieved for example that the radiology datasets can be evaluated on the basis of geographically adjacent users.

In a further technically advantageous embodiment of the database system, the analysis facility is designed in order to additionally analyze the radiology datasets on the basis of a device type with which the respective radiology datasets have been produced. The technical advantage is thereby achieved for example that the technical parameters suitable for the respective device type can be ascertained.

In a further technically advantageous embodiment of the database system, the database system comprises a performance database with datasets from a plurality of imaging devices, which datasets in each case comprise a patient throughput, a duration of the examination itemized according to clinical indication, an error rate or a repetition rate. The technical advantage is thereby achieved for example that performance criteria of the individual imaging devices can be taken into consideration.

In a further technically advantageous embodiment of the database system, the analysis facility is designed in order to additionally analyze the radiology datasets on the basis of those datasets which are stored in the performance database. The technical advantage is thereby achieved for example that the technical parameters can be selected according to performance criteria.

In a further technically advantageous embodiment of the database system, the database system comprises a transformation facility in order to transform the radiology datasets into a predetermined format. The technical advantage is thereby achieved for example that the radiology datasets can be converted into a format which is suitable for a particular imaging device.

In a further technically advantageous embodiment of the database system, the database system comprises a selection facility in order to select a radiology dataset from the anonymized radiology datasets of the other users on the basis of the previous analysis. The technical advantage is thereby achieved for example that an individual radiology dataset is ascertained for the adjustment of an imaging device.

In a further technically advantageous embodiment of the database system, the database system comprises a transmission facility in order to transmit the selected radiology dataset to an imaging device. The technical advantage is thereby achieved for example that the imaging device can be adjusted in a simple manner.

In a further technically advantageous embodiment of the database system, the imaging device can be connected via a cryptographically encoded connection to the database system. The technical advantage is thereby achieved for example that any unauthorized reading of confidential radiology datasets is prevented.

In a further technically advantageous embodiment of the database system, the imaging device is a computed tomography device. The technical advantage is thereby achieved for example that a radiation dose or X-ray dose during the medical examination can be reduced.

According to a second aspect of an embodiment, a method for the identification of technical parameters for an imaging device is disclosed, comprising the steps of storing radiology datasets of a number of users in a database; retrieving the radiology dataset from a medical examination of a user from the database; retrieving radiology datasets from a comparable medical examination of other users from the database; anonymizing the radiology datasets of the other users; and analyzing the radiology dataset of the one user on the basis of the anonymized radiology datasets of the other users. The same technical advantages are thereby achieved as by the database system according to the first aspect.

In a technically advantageous embodiment of the method, the radiology datasets of a predefined user group are retrieved from the database. The technical advantage is thereby similarly achieved for example that the user group can be restricted to a predefined circle of users having special characteristics for the purpose of analysis of the radiology datasets.

In a further technically advantageous embodiment of the method, a radiology dataset from the anonymized radiology datasets of the other users is selected on the basis of the previous analysis. The technical advantage is thereby similarly achieved for example that an individual radiology dataset is ascertained for the adjustment of an imaging device.

In a further technically advantageous embodiment of the method, the selected radiology dataset is transmitted to an imaging device. The technical advantage is thereby achieved for example that the imaging device can be adjusted in a simple manner.

According to a third aspect of an embodiment, a computer program product is disclosed, which is loaded, or can be loaded, into a memory of a computer, with computer program code for carrying out an embodiment of the method described above when the computer program product is executed on the computer.

According to a fourth aspect of an embodiment, a computer program is disclosed, with computer program code for carrying out all the method steps of an embodiment of the method described above when the computer program product is executed on a computer. In this situation it is also possible that the computer program is stored on a medium which can be read by a computer.

### BRIEF DESCRIPTION OF THE DRAWINGS

Example embodiments, which should be understood as not being restrictive, will now be described in detail together with the features and further advantages thereof, making reference to the drawings,

in which:

FIG. 1 shows a schematic view of a database system; and

FIG. 2 shows a block diagram of a method.

### DETAILED DESCRIPTION OF THE EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

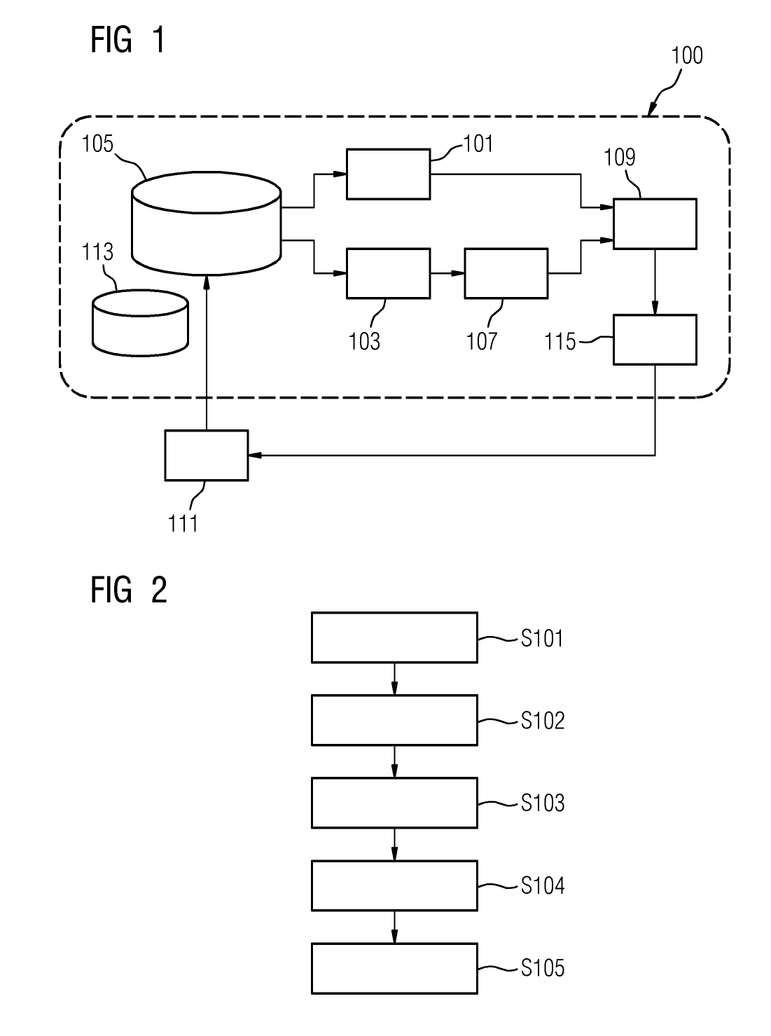

FIG. 1 shows a schematic view of a database system 100 for the identification of advantageous technical parameters for an imaging device 111. The imaging device 111 can for example be a computed tomography device or a magnetic resonance device.

The database system 100 comprises a first retrieval facility 101 for retrieval of a radiology dataset from a medical examination of a particular user from a database 105 and a second retrieval facility 103 for retrieval of radiology datasets from a comparable medical examination of other users from the database 105. An anonymization facility 107 serves to anonymize the radiology datasets of the other users, for example by overwriting fields containing personal information. An analysis facility 109 serves to analyze the radiology datasets of the one user on the basis of the anonymized radiology datasets of the other users. The analysis facility 109 can for example analyze whether an X-ray dose from one medical examination exceeds the X-ray dose from another medical examination. In addition the analysis facility 109 can analyze how the applied X-ray dose affects an image quality. The facilities 101, 103 and 107 can be extensions of a base module which is formed by the central database 105 which is connected to the imaging devices 111 by way of a secure connection in order to save base data relating to said base module's use.

One part of the database system 100 covers in particular the use of the imaging device 111 in the context of a dose monitoring process in which for each X-ray based radiological examination the applied X-ray dose in any desired physically and medically relevant units together with a location, a date, a time of day, a device type, patient data, an identification of the user and/or a scan protocol used are stored in the radiology datasets.

The user of the database system 100 is able to view and analyze his own radiology datasets in their full depth. For comparison purposes on the other hand, the radiology datasets of other users are made available in anonymized form, for example in the form of freely definable average key values (PKI—key performance indices). By this, it is possible to implement a “users-like-me” module. The user is thereby able to compare his own X-ray dose with the X-ray doses of all other users or a predefined user group of the database system 105.

Examples of limited user groups for such a comparison can be “the users in a same city”, “the users in a same region”, “the users in a same country” or “all users of a radiology device of the same type”. It is also possible that the user groups can be limited at least for the operator of the database 105 according to a manufacturer of the imaging device 111 or according to a particular device type. For this reason these radiology datasets can furthermore be used for scientific publications relating to the relative dose performance of manufacturers or to the reporting to regulatory authorities. Such evaluations can be compiled automatically and made available in functionally appropriate templates.

It is for example possible to interrogate the database system 100 in such a manner as to how low dose values from lung screening scans are in comparison with competing healthcare providers in a particular geographical area or how low dose values from neurological examinations are in comparison with all other imaging devices 111 of a particular model worldwide. The corresponding radiology datasets should be sufficiently reliable, detailed and precise in order to make possible reports generated from the database 105 for dose marketing by the corresponding healthcare providers.

Additional plug-ins for the database 105 can for example represent dose key values in comparison with other user groups and produce printouts to hand out to patients. Individual plug-ins can be integrated individually into the database system 100 and marketed on a chargeable basis. The database system 100 renders a potential for improvement with regard to an X-ray dose transparent to other comparable users and makes available a technically advantageous step toward achieving dose improvements.

Individual images produced during the examination can also be stored in the database 105 in the context of the radiology datasets. As a result the dose values achieved can be set in relation to the achieved image quality of other users. In conjunction with said images, the dose values of other users can be arranged in a useful manner in a clinical context for evaluation purposes because a lower dose could have been achieved with a degradation in image quality. It is thereby possible to decide whether a possibility for improvement exists in the examination protocols for the imaging device 111 by changing the radiation dose.

In addition, not only a captured image but also information concerning the nature of the image acquisition can be inserted in an entry in the radiology datasets. Said information comprises for example the scanner hardware or software used and also protocol settings regarding the examination. Said information is stored in a manufacturer-independent manner.

A peer-to-peer visibility of the radiology datasets can be enabled within the users of the database 105. Users who for example determine that other users of the database 105 achieve lower dose values with a comparable or better image quality for a particular medical examination can thereby view not only the manufacturer or the model of the imaging device 111 but also the complete protocol data with which said dose values or the image quality have been achieved.

These radiology datasets can then be either taken over manually or transferred automatically onto the imaging device 111 of the user having access thereto. With regard to having access to the radiology datasets of other users, anonymizing said users, for example by using pseudonyms, ensures that the privacy of other users is not violated. The access to or transfer of radiology datasets can constitute a chargeable added value, in which case the profit from a corresponding paid exchange of radiology datasets can be divided between the operator of the database 105 and the commissioning user.

A user's own stored radiology datasets can be retrieved in a suitable form by a legitimized user. In the simplest case this takes place for example by way of an output of tables. In an extended case this takes place by way of a suitable cockpit from which legitimized users are able to interrogate any desired evaluations of the technical parameters in respect of the radiology datasets obtained at the imaging devices 111.

The database 105 is constructed in such a manner that the radiology datasets of any desired users, such as for example healthcare providers, can be stored in a memory. This should be done in supplier-neutral fashion such that the dose values of imaging devices 111 from any desired manufacturers can be stored compatibly. Even if the radiology datasets of a plurality of users are stored centrally on shared servers in the database 105, data evaluations by a legitimized user can only be granted in their full depth on that user's own database. A performance database 113 can be provided for the storage of performance values for individual imaging devices 111. A transmission facility 115 serves to transmit a selected radiology dataset to an imaging device 111, for example by way of a network.

The database system 100 can in principle be coupled with any desired business models, such as for example with monthly or annual usage subscriptions on a pay-per-use basis according to a number of examinations stored. The database system 100 forms a comprehensive dose, image quality or performance data cloud which enables dose and utilization management and database based optimization. The greater the number of users included in the database 105 with their radiology datasets, the better the optimization of technical parameters that can be carried out for the respective examination.

FIG. 2 shows a block diagram of a method for setting technical parameters for an imaging device 111. The method comprises the step S101 of storing radiology datasets of a number of users in the database 105; the step S102 of retrieving the radiology dataset for a medical examination of a user from the database 105; the step S103 of retrieving radiology datasets for a comparable medical examination of other users from the database 105; the step S104 of anonymizing the radiology datasets of the other users; and the step S105 of analyzing the radiology datasets of the one user on the basis of the anonymized radiology datasets of the other users.

In the course of acquiring examination protocols conflicts may occur as a result of differences between the imaging devices 111 participating in the exchange. For example, the imaging devices 111 in question may be similar models having a similar hardware configuration. However, the one imaging device 111 may have different software installed, which optimizes an X-ray dose and image quality, than another imaging device 111. This conflict can be indicated to the owner of the other imaging device 111 during or prior to the acquisition of the corresponding software.

The user of the other imaging device 111 then has the option of using the radiology datasets on a test basis. Said user possibly determines that the desired dose and image quality are not achieved with the settings from the radiology datasets because the same software is not installed on the other imaging device 111. In this case a download of the missing software can be enabled, for example through direct purchase of the corresponding license or through acquisition of a time-limited test license free of charge. The user is thereby made aware directly and transparently as to which technical measures are available in order to improve the dose or image quality and what levels of effort and costs are involved as a result. Conversely, for the software made available by the manufacturer the user can relate directly to what technical benefit is obtained as a result. The manufacturers connected to the database 105 can communicate and sell corresponding customer upgrades with minimal technical effort. The benefit of the software becomes directly evident to the user as a result of the comparison of dose and image quality carried out on exchange of the protocols.

If it is recognized during the course of an analysis on exchange of the protocols between the two imaging devices 111 that a better dose to image quality relationship comes about as a result of the fact that the imaging devices 111 in question are basically different models, the older imaging device 111 can be replaced by the newer. This means that data-based selling (crowd-based selling) can be implemented.

For the cases in which missing software or a lower powered imaging device 111 is not a reason for a dose or image quality which is capable of improvement but where the emphasis is on a potential for improvement of operational procedures, automated training facilities can be offered, for example texts, publications or screen presentations on dose optimization, trainers or protocol optimizers.

In addition, outside of an anonymous exchange of radiology datasets it can be possible for users to establish contact directly with other users in a forum or by way of private messaging between one another, such as for example in a social network. For example, by mutual agreement parts of a user's own identity can in each case be released for a more extensive exchange within or also outside the network. It can be an objective in this situation to jointly establish collaborations in order to offer mutual support with regard to the improvement of protocols. Users can also permanently mutually unlock themselves by handshake in said social network for access to the radiology datasets of the other user, in order to offer continual mutual support in the optimization of the technical parameters.

The database system 100 can be extended in that outside of dose, image and protocol entries in the database 105 a separate performance database 113 of any desired imaging devices 111, which also comprises imaging devices 111 that function without ionizing radiation, is also provided. Said performance database 113 can contain data relating to a patient throughput, a duration of examinations itemized according to clinical indication, error rates, repetition rates, a mixture of clinical examinations performed itemized according to the imaging devices 111.

In the same manner as for the radiology datasets a cockpit can be made available to the user which gives said user full transparency regarding his own data from his imaging devices 111 and regarding usefully selectable key parameters or evaluation metrics.

The parallel performance database 113 can be combined arbitrarily with the database system 100 such that a comparison of performance values is enabled. The comparison of the performance values makes it possible to identify which technical measures can lead to improvements. Said performance-effective measures can be directly installed and acquired.

With regard to the possibility to effect a comparison with other user groups, it is generally possible to introduce certain limits, which means for example that no user can be compared with a group of less than ten other others. By way of a very marked restriction conclusions which are difficult to reconcile with data protection requirements can otherwise be drawn with regard to individual persons. The comparison with individual users within an sufficiently large reference group does not however need to be restricted because the identity of the user to be compared is anonymized.

The database system 100 enables a crowd-based-optimization with multiple technical advantages to be implemented. It provides the opportunity for the users of the database 105 to observe and to analyze their own dose values in comparison with dose values of other users. The database system 100 offers a reliable and transparent way of identifying the potential for improvement in the users' own imaging devices 111 when there is a sufficiently large number of participants in the network. Users are given the opportunity to take measures within the comparison protocols relevant to themselves in order to achieve the medically necessary dose and image quality levels. The possibility furthermore exists to render transparent and to market the optimization achieved by optimization steps in respect of the dose or image quality.

For manufacturers, the operation of such a database system 100 is attractive because both the sales of software and added-value services and also the measurability of any change are increased thereby. In addition a user can actively participate in the optimization because greater transparency and more decision options are made available directly to the user. By connecting the user to the database system 100 it is possible to reduce an implementation period for technical improvements.

If a corresponding carryover of protocols remains limited to an exchange between imaging devices 111 of one and the same manufacturer on account of technical limitations and manufacturer-specific methods, this may result in the fact that the operation of the database system 100 by a manufacturer of imaging devices 111 results in the fact that the market share can be increased. By way of suitable sales and marketing measures the manufacturer is able to affect a rapid increase in the utilization of the database system amongst that manufacturer's own customers.

Since the radiology datasets are in any case already available by way of remote connections, these can be made accessible by way of suitable framework agreements and technical solutions. If however the users of one manufacturer are in the majority in the database 105 and if the direct advantage resulting from optimization measures is directly accessible only to said users, then it is advantageous for the user to remain a part of this network and of the installed base of said manufacturer. Should said manufacturer determine in this database system 100 that the best results are achieved for an X-ray dose, this can be disclosed and made available for competitive marketing purposes.

Finally, the database system 100 enables all users to learn from one another and allows radiation doses to be reduced. This is not only in terms of radiologists or manufacturers but also serves to reduce the exposure to radiation of all patients.

All features shown and explained in conjunction with the individual embodiments of the invention can be provided in a different combination in the inventive subject matter in order at the same time to realize their advantageous effects.

The aforementioned description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure and appended claims.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one embodiment of the invention relates to a non-transitory computer-readable storage medium comprising electronically readable control information stored thereon, configured in such that when the storage medium is used in a controller of a magnetic resonance device, at least one embodiment of the method is carried out.

Even further, any of the aforementioned methods may be embodied in the form of a program. The program may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. §112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

The scope of protection of the present invention is provided by the following claims and is not restricted by the features explained in the description or shown in the figures.

What is claimed is:

1. A database system for the identification of technical parameters for an imaging device, comprising:
a first retrieval facility for retrieval of a radiology dataset from a medical examination of a user from a database;
a second retrieval facility for retrieval of radiology datasets from a comparable medical examination of other users from the database;
an anonymization facility for anonymizing the radiology datasets of the other users; and
an analysis facility for analyzing the radiology dataset of the one user on the basis of the anonymized radiology datasets of the other users.

2. The database system of claim 1, wherein the radiology dataset comprises at least one of an X-ray dose from the medical examination and an examination image from the medical examination.

3. The database system of claim 1, wherein the second retrieval facility is designed to retrieve the radiology datasets of a defined user group from the database.

4. The database system of claim 3, wherein the defined user group is locally restrictable.

5. The database system of claim 1, wherein the analysis facility is designed to additionally analyze the radiology datasets on the basis of a device type with which the respective radiology datasets have been produced.

6. The database system of claim 1, further comprising:
a performance database with datasets from a plurality of imaging devices, the datasets each comprising a patient throughput, a duration of the examination itemized according to clinical indication, an error rate or a repetition rate.

7. The database system of claim 6, wherein the analysis facility is designed to additionally analyze the radiology datasets on the basis of the datasets stored in the performance database.

8. The database system of claim 1, further comprising a transformation facility to transform the radiology datasets into a predetermined format.

9. The database system of claim 1, further comprising a selection facility to select a radiology dataset from the anonymized radiology datasets of the other users on the basis of the previous analysis.

10. The database system of claim 9, further comprising a transmission facility to transmit the selected radiology dataset to an imaging device.

11. The database system of claim 10, wherein the imaging device connectable, via a cryptographically encoded connection, to the database system.

12. The database system of claim 10, wherein the imaging device is a computed tomography device.

13. A method for the identification of technical parameters for an imaging device, comprising:
storing radiology datasets of a number of users in a database;
retrieving a corresponding one of the stored radiology dataset from a medical examination of a respective one of the users from the database;
retrieving radiology datasets from a comparable medical examination of other of the users from the database;
anonymizing the radiology datasets of the other of the users; and
analyzing the radiology dataset of the respective one of the users on the basis of the anonymized radiology datasets of the other of the users.

14. The method of claim 13, wherein the radiology datasets of a defined user group are retrieved from the database.

15. The method of claim 13, wherein a radiology dataset from the anonymized radiology datasets of the other of the users is selected on the basis of the previous analysis.

16. The method of claim 13, wherein the selected radiology dataset is transmitted to an imaging device.

17. The database system of claim 2, wherein the second retrieval facility is designed to retrieve the radiology datasets of a defined user group from the database.

18. The database system of claim 17, wherein the defined user group is locally restrictable.

19. The database system of claim 2, further comprising:
a performance database with datasets from a plurality of imaging devices, the datasets each comprising a patient throughput, a duration of the examination itemized according to clinical indication, an error rate or a repetition rate.

20. The database system of claim 19, wherein the analysis facility is designed to additionally analyze the radiology datasets on the basis of the datasets stored in the performance database.

21. The database system of claim 2, further comprising a transformation facility to transform the radiology datasets into a predetermined format.

22. The database system of claim 2, further comprising a selection facility to select a radiology dataset from the anonymized radiology datasets of the other users on the basis of the previous analysis.

23. The database system of claim 22, further comprising a transmission facility to transmit the selected radiology dataset to an imaging device.

24. The database system of claim 11, wherein the imaging device is a computed tomography device.

25. The method of claim 14, wherein a radiology dataset from the anonymized radiology datasets of the other of the users is selected on the basis of the previous analysis.

26. The method of claim 14, wherein the selected radiology dataset is transmitted to an imaging device.

27. The method of claim 15, wherein the selected radiology dataset is transmitted to an imaging device.
